(19) United States
(12) Patent Application Publication
(10) Pub. No.: US 2011/0062742 A1
(43) Pub. Date: Mar. 17, 2011

(54) VEHICLE FLOOR MAT WITH FOLDING PORTION

(75) Inventor: William G. ALFORD, Canton, OH (US)

(73) Assignee: International Automotive Components Group North America, Inc., Dearborn, MI (US)

(21) Appl. No.: 12/695,923

(22) Filed: Jan. 28, 2010

Related U.S. Application Data
(60) Provisional application No. 61/147,926, filed on Jan. 28, 2009.

(51) Int. Cl. B60N 3/04

(52) U.S. Cl. 296/97.23

(57) ABSTRACT

A floor covering or mat for a vehicle is provided, the covering including a hinged flap portion extending from one side, the hinged flap portion in a first position being folded beneath the covering or mat, for storage. In a second position, the hinged flap portion may be folded over onto the top surface of the mat and provide a protective surface and/or display a logo or other information. In a third position, the hinged flap may extend outside of the vehicle and over the door sill and bumper to bridge any gaps and provide a smooth transition for sliding items out of the cargo space. In another aspect, a floor covering for a vehicle is provided, the covering including a hinged flap portion extending from one side, wherein the hinged flap portion may be folded over onto the top surface of the covering and sides of the hinged flap portion folded up and fastened together to form a storage structure.

### CROSS-REFERENCE TO RELATED APPLICATIONS

This application claims the benefit of U.S. Provisional Application No. 61/147,926 filed on Jan. 28, 2009.

### FIELD

This disclosure is directed at floor coverings for vehicles, and more particularly to protective floor mats such as might be used in a cargo space or passenger area which include a folding portion, the folding portion having a functional purpose.

### BACKGROUND

One of the attractions to purchase vehicles such as sport utility vehicles (SUV's), minivans, station wagons and crossover versions (CUV's) is their ability to carry various types of cargo in addition to passengers. The same interior space (cargo area) may be used in a multitude of ways to carry and store such diverse items as shrubs, potting soil, lumber, hardware, other construction materials, containers filled with liquids, furniture, suitcases, bags, boxes, pets, groceries, and sporting goods. Access to the cargo areas of these vehicles may generally be provided through any of a number of different types of vehicle closure panels including sliding side doors, liftgates and double doors. Because these vehicles tend to be relatively larger in size, accessing the cargo storage area may generally require reaching into the cargo space from outside the vehicle. This may provide a poor ergonomic position of the body if one tries to lift the object from a position where one's arms are extended well away from the body.

In addition, sliding items from such storage areas in order to remove them may be made more difficult by the changes in height at the door sill and bumper, as well as by openings between these vehicle components which may require lifting to clear. Even further, the sliding or dragging of items from the storage areas may result in damage to the rubber seal on the door sill or the top surface of the bumper (picture the removal of a full 5 gallon can of gasoline from the rear cargo area of a minivan).

Another difficulty associated with storage in the vehicle relates to separating items from one another and keeping the area around one's feet or in a cargo storage space orderly. Since the vehicle stops and starts and sways during operation, items on the floor are known to slide and tip and roll.

It is known to use molded liners and containers as well as tarps and blankets in an attempt to resolve these problems; however, their cost and appearance limit their use.

An improved design connected to the floor covering in the vehicle remains needed to resolve these and other related problems.

### SUMMARY

In a first aspect, the present disclosure is directed at a floor covering or floor mat for a vehicle, comprising a molded article configured to fit within a cargo space in a vehicle, the article having sides, the article including a hinged flap portion extending from one side. In a first position the hinged flap portion is folded beneath the floor covering or mat, in a second position the hinge flap portion may be folded over onto the top surface of the floor covering or mat, and in a third position at least a portion of the hinged flap portion may extend outside of the vehicle.

In a second aspect, the present disclosure is directed at A floor covering or floor mat for a vehicle, comprising a molded article configured to fit within the passenger space in a vehicle and having sides, the article including a first hinged flap portion extending from one side wherein the first hinged flap portion includes a plurality of hinge lines disposed within the first hinged flap portion and a plurality of second hinged flap portions. In a first position the first hinged flap portion is folded beneath the floor covering or mat for storage, and in a second position the first hinged flap portion may be folded over onto the top surface of the floor covering or mat and the plurality of second hinged flap portions may be folded along the plurality of hinge lines and fastened together to form a container.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a perspective view of the rear of a minivan illustrating the cargo storages area and the floor covering having a hinged flap portion in a first position inside the vehicle;

FIG. 2 is a perspective view of the rear of the minivan of FIG. 1 illustrating the floor covering with the hinged flap portion extended outside of the vehicle;

FIG. 3 is a top view of the floor covering of FIG. 1 with the hinged flap portion extended;

FIG. 4 is a top view of the floor covering of FIG. 1 with the hinged flap portion folded over onto the top surface of the floor covering;

FIG. 5 is a top view of another embodiment of this disclosure illustrating a three-sided hinged flap extending from the side of a floor mat;

FIG. 6 is a partial perspective view of the rear of the minivan of FIG. 1 illustrating the three-sided hinged flap in a deployed position to form a storage container;

FIG. 7 is another embodiment of this disclosure illustrating top view of a floor mat for the passenger area of a vehicle having a trapezoidal hinged flap portion;

FIG. 8 is a perspective view of the floor mat of FIG. 7 in a foot well of a vehicle with the trapezoidal hinged flap portion folded over onto the top surface of the mat to form a storage container.

### DETAILED DESCRIPTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The phrase “floor covering” in the present application is understood to mean any plastic material or combination of materials that may lie directly on the floor of the interior of a motor vehicle to protect and/or cushion the vehicle floor. These may include injection or compression molded plastic articles, comprising, but not limited to, polyvinyl chloride (PVC), acrylonitrile-butadiene-styrene (ABS), polypropylene (PP), thermoplastic elastomers (TPO's, TPE's) and rubber compounds (SBR's), etc. The floor covering may also comprise a number of layers of materials such as a carpet layer, decoupler layer and mass layer as is known in the art. The layers may be affixed to one another by adhesive or be separated by other intermediate layers.

The word “mat” in the present application is understood to mean a molded article that may cover a portion of a floor covering to protect such from wear, soiling, etc. Generally, such mats may comprise plastic or rubber materials.

It is contemplated that the present disclosure applies equally to floor covering and/or mats used in motor vehicles.

The present disclosure is directed at a floor covering or mat for the cargo storage area of a vehicle wherein a hinged flap portion may extend from one edge, the flap portion in a first position folded out of sight beneath the covering or mat, for storage. In a second position, the hinged flap portion may be folded over onto the top surface of the mat and provide a protective surface and/or display a logo or other information. In a third position, the hinged flap may extend outside of the vehicle and over the door sill and bumper (if applicable) to bridge any gaps and provide a smooth transition for sliding items out of the cargo space.

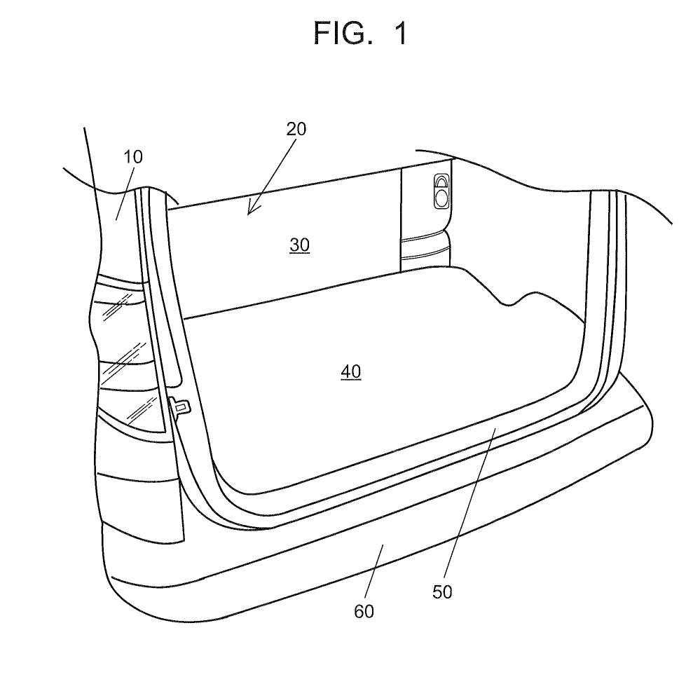

In a first exemplary embodiment, FIG. 1 is a perspective view of the rear of a minivan 10 with the rear compartment door (not shown) open and a cargo storage area 20 exposed. Within the cargo space 20 there is a view of the backside of the rear seat 30 and a floor covering 40. The floor covering may be of multi-layered construction and include protective layers for sound attenuation, heat insulation, anti-slip, and dirt collection as well as a fibrous, color coordinated top layer (for instance, a porous carpet layer overlying a fibrous decoupler layer overlying a sound attenuating mass layer). The floor covering may cover the entire floor area of the cargo space 20 or may be in the form of a mat that covers a portion of the floor covering. Also visible in FIG. 1 are the door sill 50 and rear bumper 60. The cargo storage area 20 may generally be used to store and transport a wide variety of items having complex shapes and of varying weight.

For heavy and/or large items stored or transported in the cargo space 20, it may often be difficult to remove these items without damaging the door sill or bumper as reaching into the space may place one in a poor ergonomic position to lift the item out.

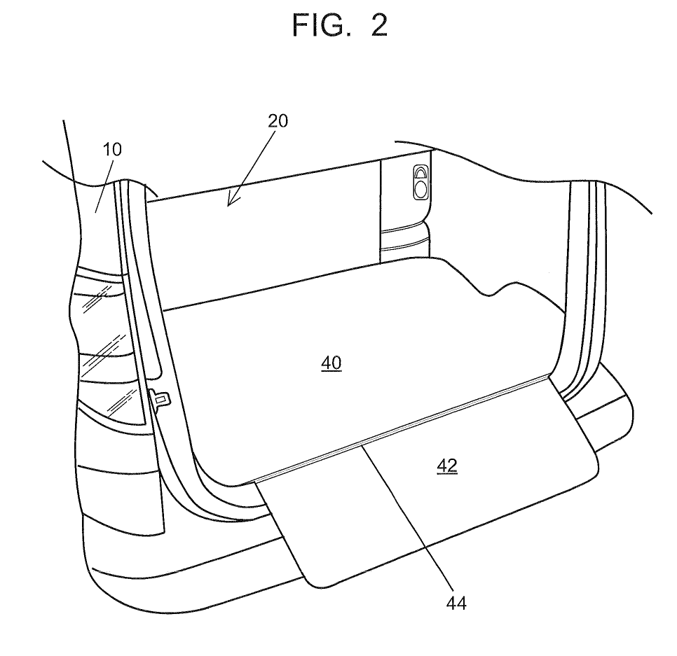

FIG. 2 is a perspective view of the floor covering of FIG. 1 with a hinged flap portion 42 unfolded from a first storage position under the covering (in FIG. 1) such that it extends out of the vehicle and over the door sill and bumper. This may provide a smooth and continuous transition from the inside of the vehicle to the outside, providing a relatively easy means to slide heavy, bulky items from within the cargo space. Differences in relative height of the components of the vehicle and gaps between components may be bridged by the flap portion 42. The flap portion 42 further may provide protection to the seal and sill surface of the rear door opening as well as to the top of the bumper from damage due to sliding items across those areas. Further, the flap portion may protect latching mechanisms for the door of the vehicle. This device may prevent the need to lift heavy, bulky items from within the cargo space and may allow one to slide such items for removal.

The flap portion 42 is capable of being rotated around a hinge line 44 to a first position stored under the mat 40, to a second position folded over onto the top surface of the covering or mat and to a third extended position as shown in FIG. 2. One or more hinges 44 may be provided to facilitate localized folding and/or positioning of the hinged flap portion. The hinge 44 may have any suitable configuration. For example, the hinge 44 may include one or more indentations that are integrally formed in the back side of the floor covering 40. The hinge 44 may be generally configured as a line and may generally extend from one edge of the hinged flap portion 42 another. The hinge 44 may be configured as an area of reduced material thickness to provide additional localized flexibility of the floor covering or mat 40. As an integral hinge, it may not be visible on the top surface of the mat. It is further contemplated that the hinge could be a separate component which may be molded into or assembled to the floor covering and flap portion by such processes as adhesive, fastener, sewing, or bonding techniques, such as ultrasonic welding, sonic welding, heat bonding, etc.

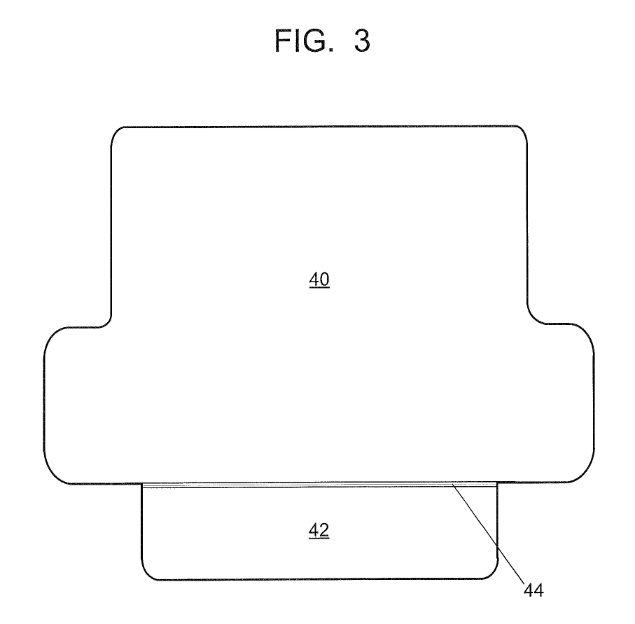

FIG. 3 is a top view of the cargo mat or floor covering 40 illustrating the hinged flap portion 42 in an unfolded and extended position and the hinge line 44. The hinge line 44 may be an area of thinner cross-section than the main body of the mat or floor covering and may include a linear depression in the front and/or rear surface.

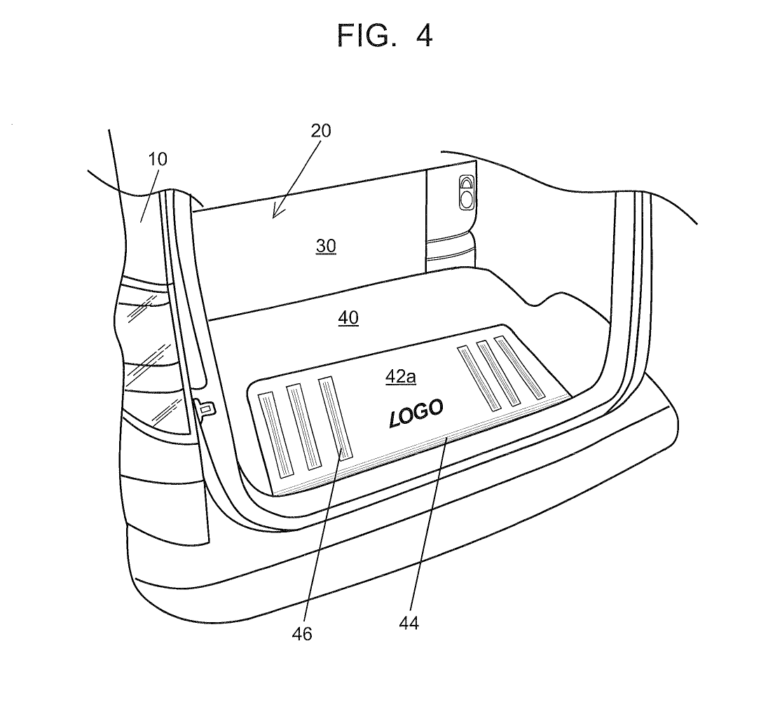

FIG. 4 is a perspective view of the cargo space as shown in FIG. 1 illustrating the hinged flap 42 folded over on to the surface of the floor covering 40, in the second position described above. In this position, the flap portion 42 may provide a protective surface for a portion of the floor covering 40 and may include on its backside 42a textured or roughened portions to provide an anti-slip surface as well as logos or other graphics. The hinge line 44 may include a single thinned area, multiple parallel thinned areas (as shown in FIG. 4) or be a living hinge. The backside 42a of the hinged flap portion may further include a series or pattern of indentations 46 or raised projections that may be capable of accepting standard sized, or specific shapes of containers to secure such from sliding (tool box, gas can, etc).

The present disclosure is further directed at a floor covering or mat for a vehicle wherein a three-sided hinged flap portion may extend from one edge of the mat, the flap portion in a first position folded out of sight beneath the covering or mat, for storage. In a second position, the hinged flap portion may be folded over onto the top surface of the mat and the corners of the three sides brought together to form a three-sided box structure for the controlled storage of small or like items.

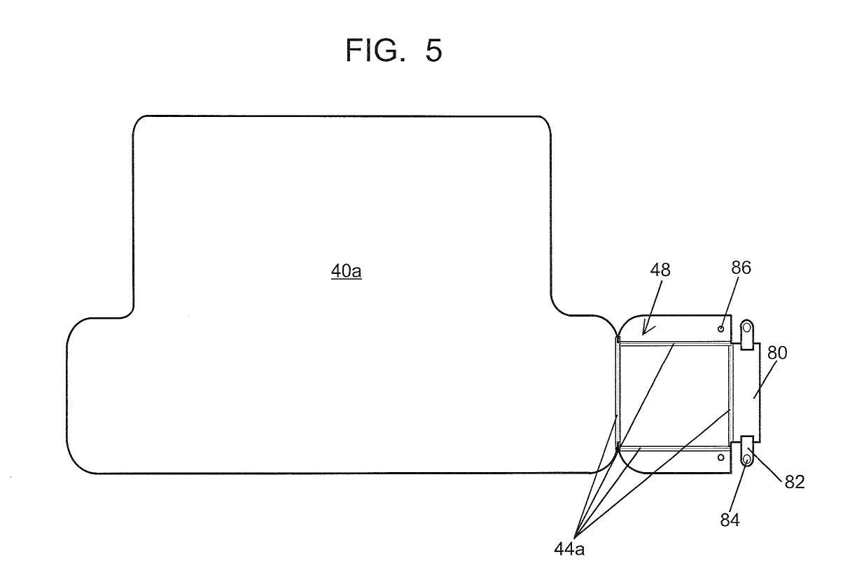

In this second exemplary embodiment, a top view of a cargo mat or floor covering 40a having a different three-sided hinged flap portion 48 extending from a side is shown in FIG. 5. This flap portion 48 may include 4 hinge lines 44a and another hinged flap portion 80 which may be folded up as sides and fastened together to form a storage container 70.

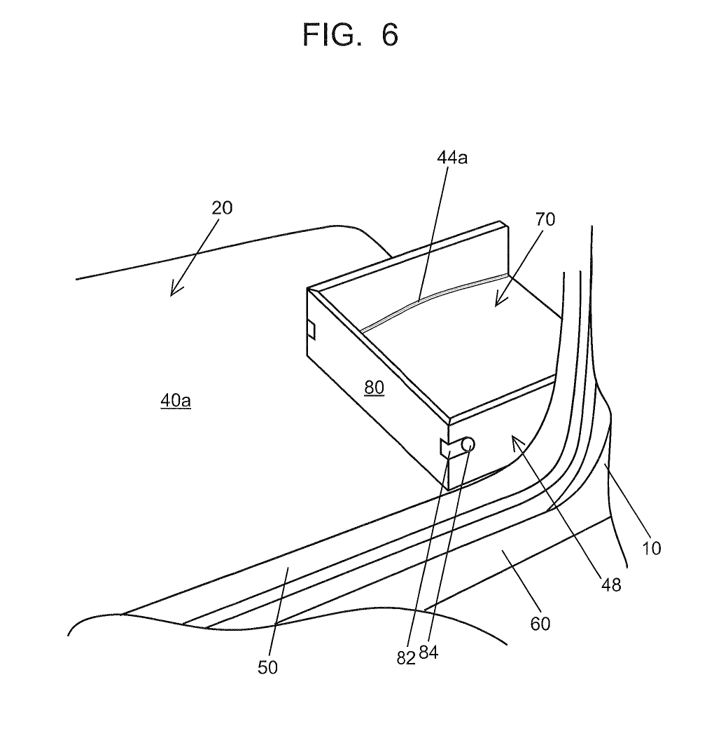

FIG. 6 shows this folded up configuration 70 in the cargo space 20 of the minivan 10 of FIG. 1. The three-sided flap portion 48 may be folded over onto the surface of the covering 40a and the sides of the three-sided flap portion 48 folded up (90°) and connected to a plurality of second hinged flap portions 80 to form a three-sided container 70, with the wall of the cargo space forming the fourth wall. The three sides may be connected together by straps 82 having female snap portions 84 that engage with complementary male snap portions 86 located on the side portions of the hinged flap portion 48. It is contemplated that other fastening means, including but not limited to, buttons, hook and loop fasteners, elastic bands and tie strings may be used. Also shown are a series of hinge lines 44a which are generally disposed in a rectangular configuration which allow the flap portion 48 to be folded into a three-sided box shape. In a collapsed or storage position, the three-sided flap portion may be folded beneath the floor covering or mat, out of sight (see FIG. 1).

It is further contemplated that the hinged flap portion may be configured to include slots and ear portions that may be engaged as with a cardboard box to assemble the container.

In a third aspect, the present disclosure is directed at a floor covering or mat for the passenger area of a vehicle wherein a three-sided hinged flap portion may extend from one edge of the mat, the flap portion in a first position folded out of sight beneath the covering or mat, for storage. In a second position, the hinged flap portion may be folded over onto the top surface of the mat, near the feet of an occupant, and the corners of the three sides brought together to form a three-sided box structure for the controlled storage of small or like items. Accordingly, the hinged flap may be square or trapezoidal in shape.

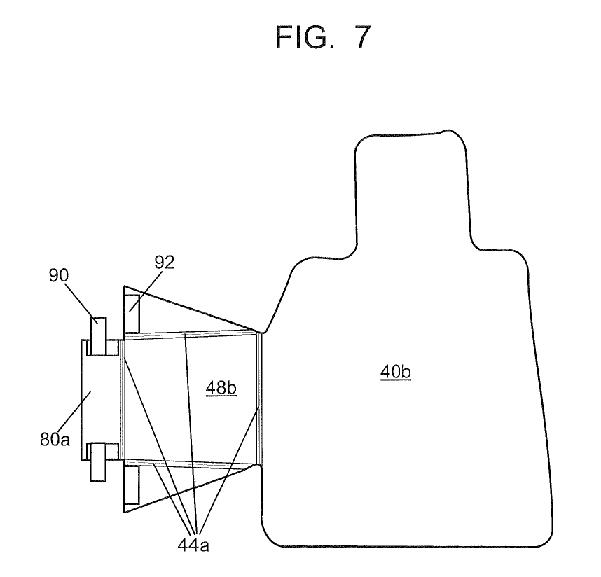

FIG. 7 illustrates the third exemplary embodiment, this time for use in a passenger space in a vehicle, for instance in a foot well. In this example, a floor mat 40b may be configured to shape to fit into a foot well adjacent the console or tunnel area, for instance, of a vehicle and have a trapezoidal hinged flap portion 48a which further includes a smaller hinged flap portion 80a to act as one side. Further included are hinge lines 44a and hook and loop fastening strips 90, 92.

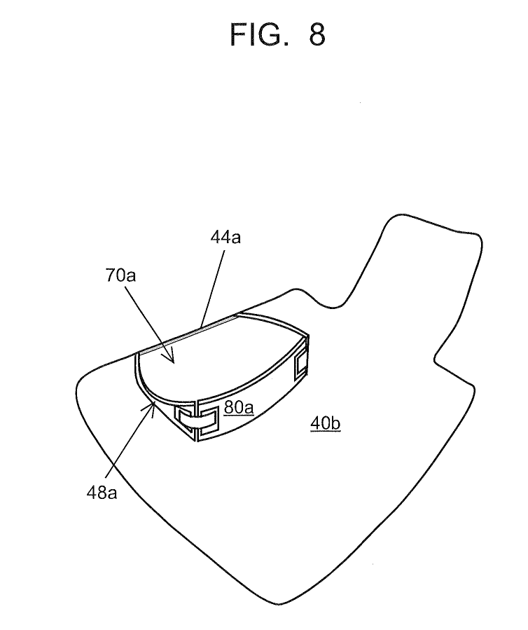

FIG. 8 illustrates the hinged flap portion 48a folded up onto the top surface of the mat 40b to form a container 70a. The two lateral sides of the hinged flap portion 48a and the smaller flap portion 80a have been folded up (90°) and connected together by hook and loop fastening strips 90, 92. To provide additional rigidity, the sides of the flap portion 48a may include molded-in ribs. Such a container may be used to contain groceries, or even a small pet. As with the previous embodiment, the trapezoidal flap 80a may be folded under the main body 40b of the mat in a position for storage when not in use.

It is further contemplated that the floor coverings or mats disclosed herein may be reversible, that is, have a finished surface on both top and bottom sides to provide differentiation in color, pattern, material composition, surface properties to extend their use and life.

The description and drawings illustratively set forth the presently preferred invention embodiments. The description and drawings are intended to describe these embodiments and not to limit the scope of the invention. Those skilled in the art will appreciate that still other modifications and variations of the present invention are possible in light of the above teaching while remaining within the scope of the following claims. Therefore, one may practice the invention otherwise than as the description and drawings specifically show and describe.

What is claimed is:

1. A floor covering or floor mat for a vehicle, comprising:
a molded article configured to fit within a cargo space in a vehicle, said article having sides;
said article including a hinged flap portion extending from one side;
wherein in a first position the hinged flap portion is folded beneath said floor covering, in a second position the hinge flap portion may be folded over onto the top surface of said floor covering or mat, and in a third position at least a portion of the hinged flap portion may extend outside of said vehicle.

2. The floor covering or floor mat of claim 1 wherein said cargo space is located adjacent a door opening having a door sill and in said third position the hinged flap portion covers at least a portion of said door sill.

3. The floor covering or floor mat of claim 2 wherein said door opening is for a rear door adjacent a bumper and a portion of said flap portion overlies at least a portion of said bumper.

4. The floor covering or floor mat of claim 1 wherein said floor covering or said floor mat is a molded article.

5. The floor covering or floor mat of claim 1 wherein said floor covering or said floor mat comprises a plurality of layers.

6. The floor covering or floor mat of claim 1 wherein said hinged flap portion is integrally formed with said floor covering or floor mat and connected along one or more hinge lines.

7. The floor covering or floor mat of claim 6 wherein said one or more hinge lines comprise one or more depressions in the front and/or rear surface of said floor covering or floor mat.

8. The floor covering or floor mat of claim 1 wherein said hinged flap portion is connected to said floor covering or floor mat by a separate hinge.

9. The floor covering of claim 1 wherein said hinged flap portion includes a back side and said back side includes one or more of logos, depressions, protrusions, and texture.

10. The floor covering or floor mat of claim 5 wherein said plurality of layers includes a top layer of carpet.

11. A floor covering or floor mat for a vehicle, comprising:
a molded article configured to fit within the passenger space in a vehicle and having sides;
said article including a first hinged flap portion extending from one side;
said first hinged flap portion including a plurality of hinge lines disposed within said first hinged flap portion and a plurality of second hinged flap portions;
wherein in a first position the first hinged flap portion is folded beneath said floor covering or mat for storage, and in a second position the first hinged flap portion may be folded over onto the top surface of said floor covering or mat and said plurality of second hinged flap portions may be folded along said plurality of hinge lines and fastened together to form a container.

12. The floor covering or floor mat of claim 11 said floor covering or said floor mat is a molded article.

13. The floor covering or floor mat of claim 11 wherein said floor covering or said floor mat comprises a plurality of layers.

14. The floor covering or floor mat of claim 11 wherein said first hinged flap portion is integrally formed with said floor covering or floor mat and connected along said plurality of hinge lines.

15. The floor covering or floor mat of claim 14 wherein said plurality of hinge lines comprise one or more depressions in the front and/or rear surface of said floor covering or floor mat.

16. The floor covering or floor mat of claim 11 wherein said hinged flap portion is connected to said floor covering or floor mat by a separate hinge.

17. The floor covering or floor mat of claim 11 wherein said first hinged flap portion is generally rectangular in shape.

18. The floor covering or floor mat of claim 11 wherein said first hinged flap portion is generally trapezoidal in shape.

19. The floor covering or floor mat of claim 11 wherein said opposing sides and said second hinged flap portion are fastened together to form a three-sided container by one or more of snap fasteners, hook and loop fasteners, elastic bands, tie strings and buttons.

20. The floor covering or floor mat of claim 13 wherein said plurality of layers includes a top layer of carpet.
